(19) United States
(12) Patent Application Publication
(10) Pub. No.: US 2025/0366663 A1
(43) Pub. Date: Dec. 4, 2025

(54) MULTIFUNCTIONAL OVEN

(71) Applicant: LINHAI GUANGHE CRAFTS CO.,LTD, LINHAI (CN)

(72) Inventors: Miao Wang, LINHAI (CN); Jue Wang, LINHAI (CN)

(21) Appl. No.: 18/679,219

(22) Filed: May 30, 2024

(51) Int. Cl. A47J 37/07; F24C 1/16; F24C 15/18

(52) U.S. Cl. CPC A47J 37/0786; F24C 15/18; F24C 1/16; A47J 2037/0777; A47J 2202/00

(57) ABSTRACT

The present application relates to a multifunctional oven, and relates to the field of ovens. The multifunctional oven comprises an oven body and a grill detachably connected to the oven body; extension platforms are hinged on the oven body; the oven body is provided with positioning assemblies; the extension platforms are provided with accommodating grooves; the extension platforms are provided with a plurality of through holes; flip plates are rotatably connected in the through holes; and the flip plates are provided with clamping members. When tools and the oven need to be transported to a barbecue location together, the tools can be stored in the accommodating grooves, thereby improving the usability of the oven.

### TECHNICAL FIELD

The present application relates to the field of ovens, in particular to a multifunctional oven.

### BACKGROUND

An oven is a device that forms hot air to bake and cook foods. During installation and use of the oven, various tools such as screwdrivers, seasoning brushes, clamps and the like are required to be used. When the above tools and the oven need to be transported to a barbecue location together, a lot of space is occupied. Moreover, the various tools are placed in a messy manner and may collide with each other during transportation, resulting in damage to the tools, such that an improvement is required.

### SUMMARY

To improve user's control over a temperature in an oven, the present application provides a multifunctional oven.

The present application provides a multifunctional oven, which adopts the following technical solution:

A multifunctional oven comprises an oven body and a grill detachably connected to the oven body; extension platforms are hinged on the oven body; the extension platforms are flipped to be close to or away from the oven body; the oven body is provided with positioning assemblies for positioning the extension platforms; the extension platforms are provided with accommodating grooves; when the extension platforms are horizontal, the accommodating grooves are located below the extension platforms; the extension platforms are provided with a plurality of through holes; the plurality of through holes are distributed towards a direction away from the oven body; the through holes are in communication with the accommodating grooves; flip plates are rotatably connected in the through holes; rotation axes of the flip plates are perpendicular to hinge axes of the extension platforms; and the flip plates are provided with clamping members.

By adopting the above technical solution,

when tools and the oven need to be transported to a barbecue location together, the flip plates can be flipped, such that the clamping members are located in the accommodating grooves; and the tools are then clamped by the clamping members, and the extension platforms are then flipped, such that the extension platforms abut against the oven body, and the extension platforms are positioned. In this case, the tools can be stored in the accommodating grooves, such that a space occupied by the tools is reduced; and the tools are clamped by the clamping members to be positioned, such that the tools can be prevented from being damaged by collision with each other during transportation, and the usability of the oven is improved.

When the oven is used, the extension platforms can be flipped, such that the extension platforms are horizontal, and the extension platforms are positioned. The tools required for barbecue are then removed from the clamping members, and the flip plates, on which the clamping members do not clamp items, are then flipped, such that the clamping members are located above the extension platforms. In this case, tools that are not required for the moment can be clamped by the clamping members to reduce the situation that the tools fall from the extension platforms, so as to be convenient for workers to take and use. Baked and plated foods can further be placed between the clamped tools and the oven body to limit the position of the foods, such that the situation that the plated foods fall from the extension platforms due to accidental collision in a process of taking items is reduced.

Optionally, the clamping members are elastic pieces, two opposite ends of the elastic pieces are connected to the flip plates, and the elastic pieces and the flip plates are splicedto form perforation holes.

By adopting the above technical solution, when tools need to be clamped, the tools may penetrate through the perforation holes, and the elastic pieces deform according to sizes of the tools, thereby enabling tools of different sizes to tightly abut against the flip plates to achieve clamping, making it more convenient to clamp the tools, and improving the applicability of the clamping members.

Optionally, each flip plate comprises a plate body rotatably connected to the storage platform and a sliding block slidably connected to the plate body. The clamping members are provided on the sliding blocks. Sliding directions of the sliding blocks are perpendicular to rotation axes of the plate bodies. The plate bodies are provided with locking assemblies for positioning the sliding blocks.

By adopting the above technical solution, some tools, such as scissors, have large differences in sizes of various parts thereof, and a partial (scissor handle) size exceeds a range of deformation of the elastic pieces. Therefore, when a tool is clamped, the tool can be clamped only by the elastic piece tightly abutting against a part (a scissor blade), a size of which does not exceed the range of deformation of the elastic piece, of the tool. Moreover, a length of the above part (the scissor blade) that does not exceed the range of deformation of the elastic piece is inconsistent with a length of a part that exceeds the range of deformation of the elastic piece, which may cause the tool to be partially stuck by the storage platform or fall to an outer side of the storage platform after the elastic piece tightly abuts against the tool to achieve clamping, resulting in a poor storage effect. In this case, the entire clamped tool can be located in the accommodating groove by moving the sliding block, and the sliding block is then positioned, which facilitates the improvement of a storage effect of the accommodating groove.

Optionally, the locking assembly comprises a movable block slidably connected to the plate body, a plurality of snap blocks provided on the movable block, a second elastic member provided on the plate body, and a limiting block rotatably connected to the movable block. The movable block is moved to be close to or away from the sliding block. The plurality of snap blocks are distributed along the sliding direction of the sliding block. The sliding block is provided with snap slots for the snap blocks to snap thereinto. The second elastic member tightly abuts against the movable block, such that the movable block has a tendency to be close to the sliding block. The plate body is provided with an avoiding slot for the limiting block to snap thereinto. When the limiting block is snapped into the avoiding slot, the snap blocks are disengaged from the snap slots.

By adopting the above technical solution, when the sliding block needs to be moved, the limiting block is twisted, such that the limiting block is aligned with the avoiding slot; and the limiting block is then pressed to drive the movable block to move away from the sliding block, such that the limiting block is snapped into the avoiding slot and the snap blocks are disengaged from the snap slots, and the sliding block can thus be moved. When the sliding block moves to a corresponding position and the snap slots are aligned with the snap blocks, the limiting block is released, the movable block drives, under the action of the second elastic member, the snap blocks to be snapped into the snap slots, the snap blocks abut against inner walls of the snap slots, and the sliding block can thus be positioned. Then, the limiting block is twisted, such that the limiting block is staggered from the avoiding slot, and the plate body abuts against the limiting block to limit the limiting block, thereby reducing the situation that the snap blocks are disengaged from the snap slots due to the fact that the tool clamped by the clamping member presses the limiting block, and improving the stability of positioning of the sliding block.

Optionally, the limiting block and the plate body are spliced to form a recess, the recess is located on the side of the limiting block that is close to the sliding block, and the recess is for the sliding block and the elastic piece to snap thereinto.

By adopting the above technical solution, when a size of the tool is smaller than that of the perforation hole, the sliding block can be moved to be close to the limiting block, such that the sliding block and the elastic piece are snapped into the recess, and the limiting block tightly abuts against the elastic piece, thereby dividing the perforation holes into smaller apertures, making it convenient to clamp the tool of the size smaller than the perforation holes, and further improving the applicability of the clamping member.

Optionally, the positioning assemblies comprise linkage blocks slidably connected to the oven body, a plurality of insertion blocks provided on the linkage blocks, and adjustment blocks in threaded connection to the oven body; the linkage blocks are slid to be close to or away from the extension platforms; the plurality of insertion blocks are located on the sides of the linkage blocks that are close to the extension platforms, and are circumferentially distributed around the hinge axes of the extension platforms; the extension platforms are provided with positioning holes for the insertion blocks to pass through; and the adjustment blocks and the linkage blocks are rotatably connected.

By adopting the above technical solution, when the extension platforms need to be flipped, the adjustment blocks are twisted, and the adjustment blocks drive the linkage blocks to move away from the extension platforms, such that the insertion blocks are disengaged from the positioning holes, and the extension platforms can be rotated until the extension platforms are rotated to corresponding positions and the positioning holes are aligned with the insertion blocks. The adjustment blocks are then twisted in opposite directions, and the adjustment blocks drive the linkage blocks to move close to the extension platforms, such that the insertion blocks pass through the positioning holes, and the extension platforms can be positioned by enabling the insertion blocks to abut against inner walls of the positioning holes, making positioning of the extension platforms more convenient.

Optionally, the grill is provided with a plurality of mounting columns, and the oven body is provided with mounting slots for the mounting columns to snap thereinto.

By adopting the above technical solution, when foods need to be baked, the mounting columns on the grill are snapped into the mounting slots, such that the grill is placed on the oven body, and the foods can thus be placed on the grill for baking. When the grill needs to be cleaned, the grill is lifted, such that the mounting columns are disengaged from the mounting slots, and the grill can thus be removed for separate cleaning, making cleaning of the grill more convenient.

Optionally, the grill comprises a base plate provided on the oven body and a cover body provided on the base plate; the mounting columns are provided on the base plate; the cover body and the base plate are spliced to form a heating space; the cover body is provided with a thermometer; and a temperature sensing element of the thermometer extends into the heating space.

By adopting the above technical solution, a temperature in the heating space can be mastered in real time by observing a reading of the thermometer, so that a cook better masters a baking degree, and baked foods are made more delicious.

In summary, the present application comprises at least one of the following beneficial technical effects:

1. When tools and the oven need to be transported to a barbecue location together, the flip plates can be flipped, such that the clamping members are located in the accommodating grooves; and the tools are then clamped by the clamping members, and the extension platforms are then flipped, such that the extension platforms abut against the oven body, and the extension platforms are positioned. In this case, the tools can be stored in the accommodating grooves, such that a space occupied by the tools is reduced; and the tools are clamped by the clamping members to be positioned, such that the tools can be prevented from being damaged by collision with each other during transportation, and the usability of the oven is improved.

2. When tools having large differences in size of various parts need to be clamped, the entire clamped tools can be located in the accommodating grooves by moving the sliding blocks, and then the sliding blocks are positioned to help improve a storage effect of the accommodating grooves.

3. When the size of the tools is smaller than that of the perforation holes, the sliding blocks can be moved to be close to the limiting blocks, such that the sliding blocks and the elastic pieces are snapped into the recesses, and the limiting blocks tightly abut against the elastic pieces, thereby dividing the perforation holes into smaller apertures, making it convenient to clamp the tools of the size smaller than the perforation holes, and further improving the applicability of the clamping members.

### BRIEF DESCRIPTION OF DRAWINGS

FIG. 1 is an overall schematic diagram of an embodiment of the present application.

FIG. 2 is a partial exploded structural view of an embodiment of the present application.

FIG. 3 is a structure diagram of an embodiment of the present application partially dissected at a positioning assembly.

FIG. 4 is an enlarged view of Part A in FIG. 3, mainly illustrating a structure of the positioning assembly.

FIG. 5 is a structure diagram of an embodiment of the present application partially dissected at an extension platform, mainly illustrating a structure of an accommodating groove.

FIG. 6 is a partially dissected structure diagram of an embodiment of the present application at a plate body, mainly illustrating a structure of a locking assembly.

FIG. 7 is an enlarged view of Part B in FIG. 5, mainly illustrating a structure of a perforation hole.

Explanation of Reference Numerals: 1, oven body; 11, mounting slot; 12, limiting slot; 2, grill; 21, base plate; 22, cover body; 3, mounting column; 4, heating space; 5, thermometer; 6, extension platform; 61, positioning hole; 62, accommodating groove; 63, through hole; 7, positioning assembly; 71, linkage block; 72, insertion block; 73, adjustment block; 8, limiting bump; 9, flip plate; 91, plate body; 911, accommodating cavity; 912, avoiding hole; 913, avoiding slot; 92, sliding block; 921, snap slot; 10, clamping member; 101, elastic piece; 13, perforation hole; 14, locking assembly; 141, movable block; 1411, sliding portion; 1412, connecting portion; 142, snap block; 143, second elastic member; 144, limiting block; 15, recess.

### DETAILED DESCRIPTION OF THE EMBODIMENTS

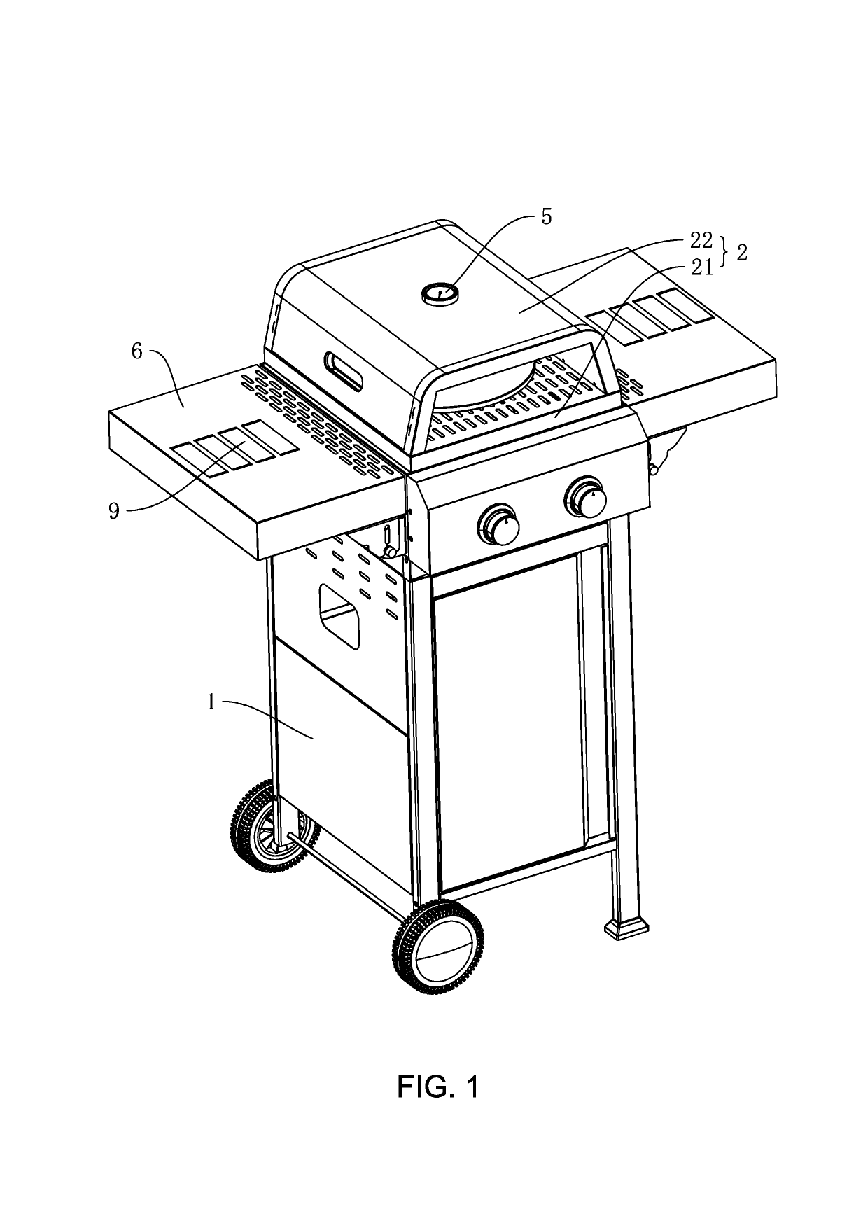

The present application will be further described in detail below in conjunction with FIGS. 1-7.

The embodiments of the present application disclose a multifunctional oven.

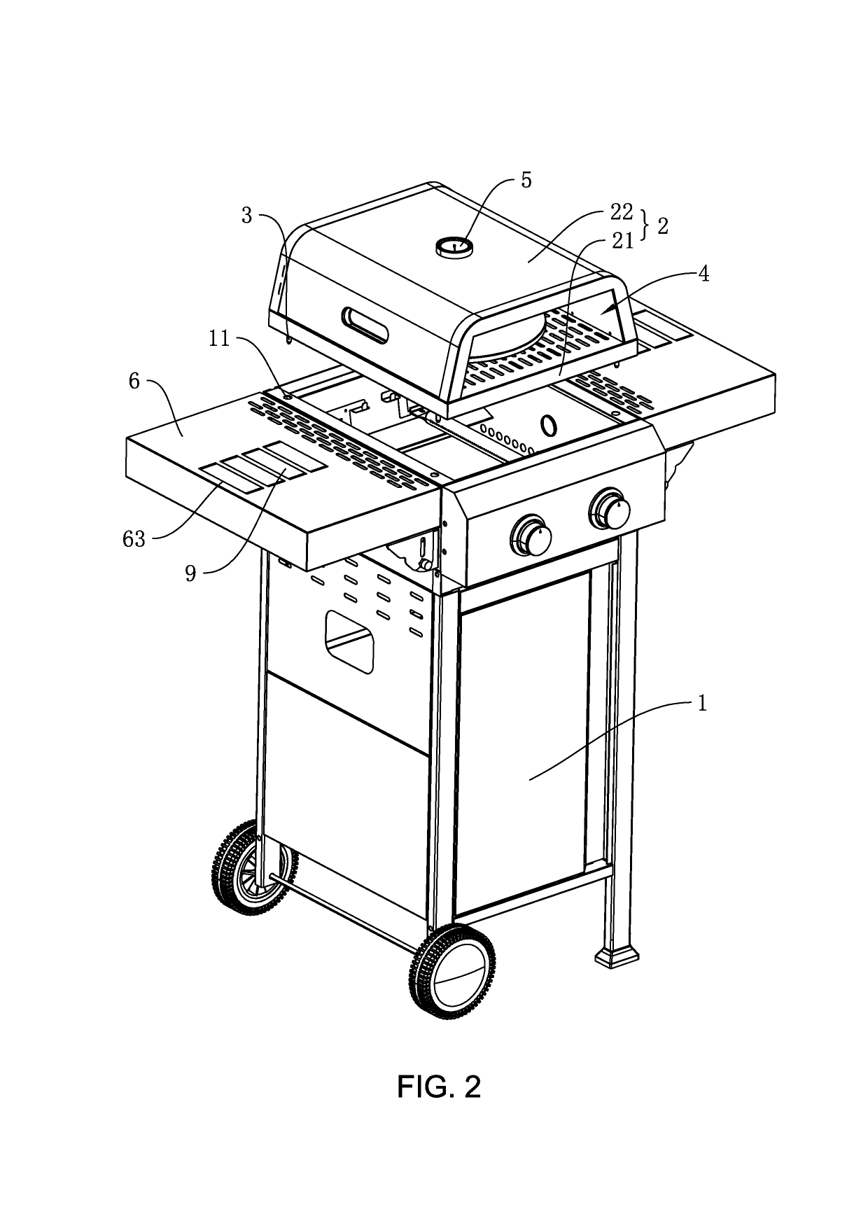

With reference to FIG. 1 and FIG. 2, the multifunctional oven comprises an oven body 1 and a grill 2. The grill 2 comprises a base plate 21 and a cover body 22. The base plate 21 is located above the oven body 1. A plurality of mounting columns 3 are fixed on a lower end surface of the base plate 21. The plurality of mounting columns 3 are circumferentially distributed at intervals around the periphery of the base plate 21. An outer side wall of the oven body 1 is provided with a plurality of mounting slots 11. The number and positions of the mounting slots 11 correspond to the number and positions of the mounting columns 3 on a one-to-one basis. The mounting slots 11 are used for the corresponding mounting columns 3 to snap thereinto. The base plate 21 is detachably connected to the oven body 1 by means of mating between the mounting columns 3 and the mounting slots 11.

It should be noted that the mode of detachable connection between the oven body 1 and the base plate 21 is not limited to the implementation mode disclosed in the present embodiment, and any other structure that can achieve this function can be used.

In actual use, the base plate 21 can be replaced with a plate for baking pizza/barbecue/teppanyaki according to requirements. That is, the base plate 21 is replaced with a plate for baking specific foods according to requirements of different foods to be baked.

With reference to FIG. 1 and FIG. 2, the cover body 22 is located above the base plate 21 and fixedly connected to the base plate 21. The cover body 22 and the base plate 21 are spliced to form a heating space 4. A thermometer 5 is fixed on the cover body 22, and a temperature sensing element of the thermometer 5 extends into the heating space 4. A temperature in the heating space 4 can be grasped in real time by observing a reading of the thermometer 5, such that a cook better controls a baking degree.

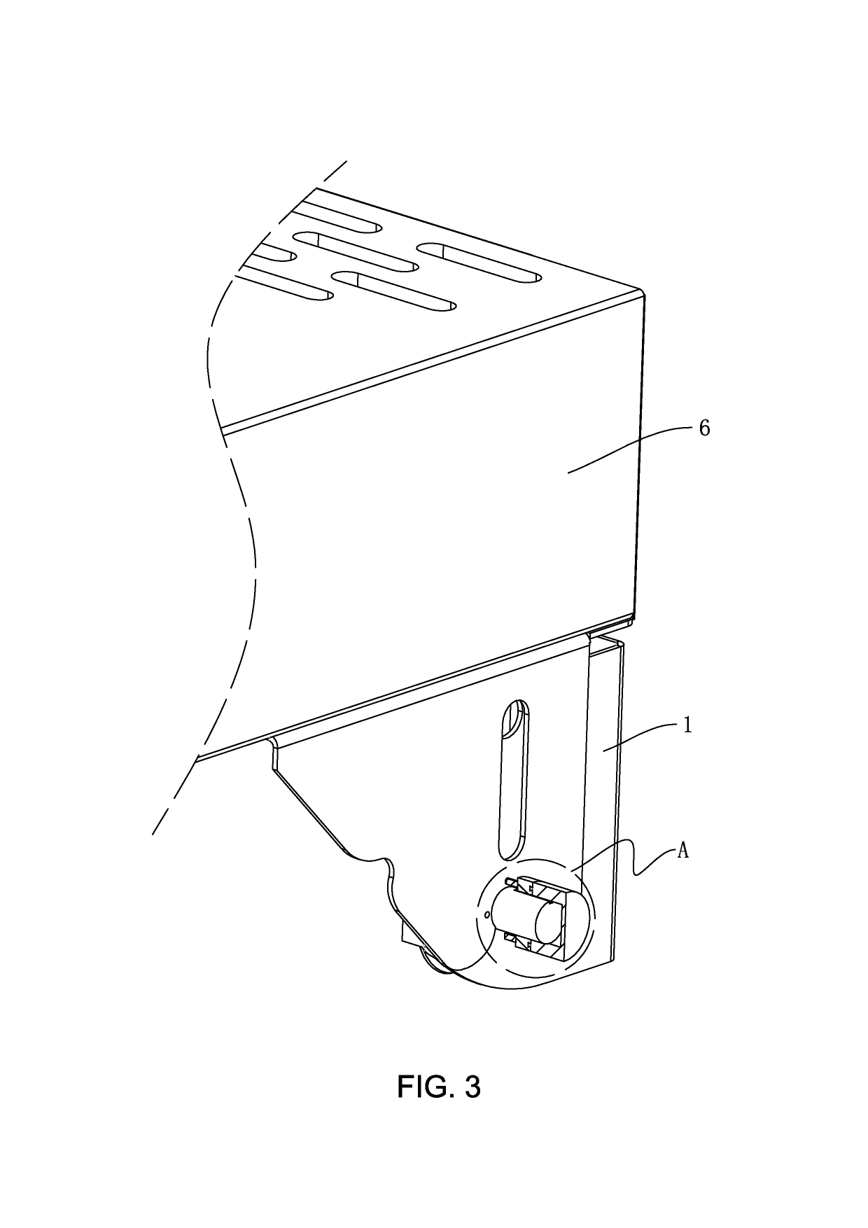

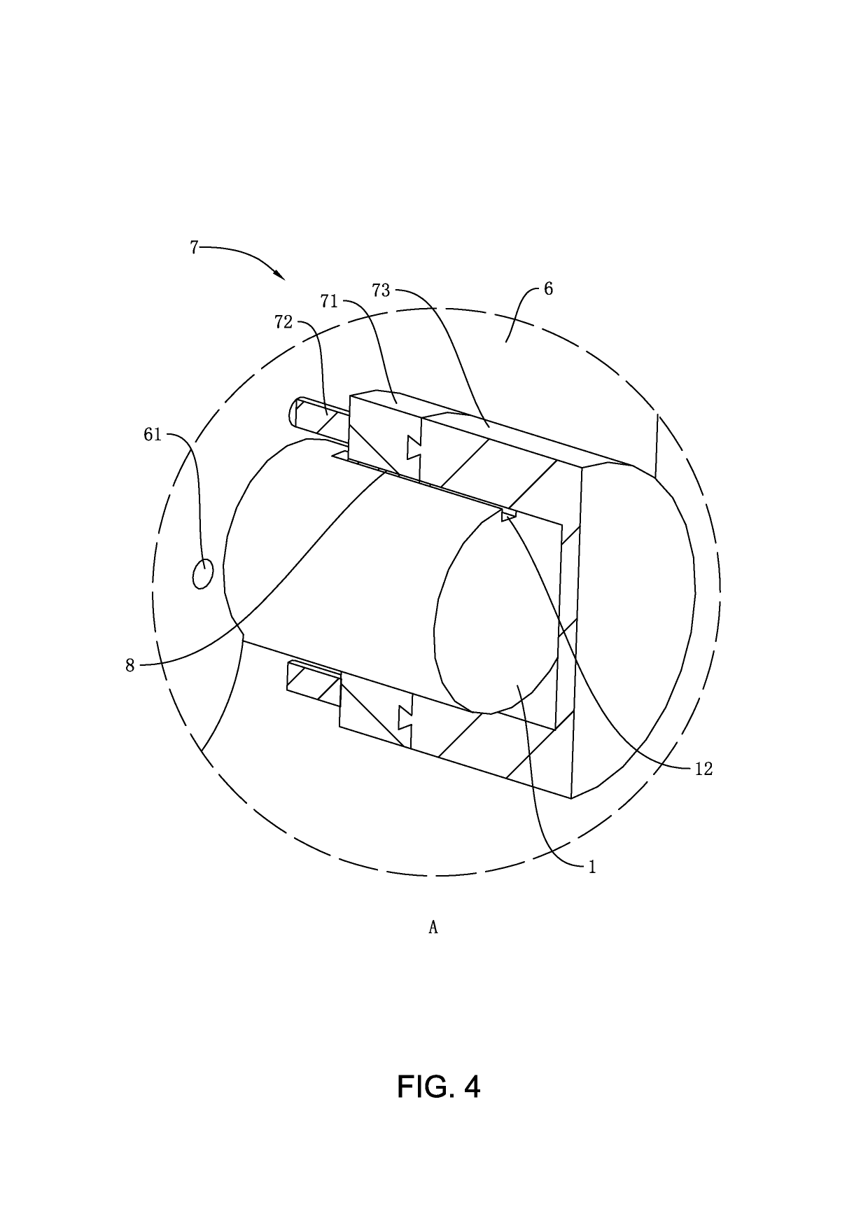

With reference to FIG. 3 and FIG. 4, two extension platforms 6 are hinged on the oven body 1. The two extension platforms 6 are located on two opposite sides of the oven body 1, respectively. Hinge axes of the extension platforms 6 are disposed horizontally, and the extension platforms 6 are flipped to be close to or away from the oven body 1. The oven body 1 is provided with positioning assemblies 7. The positioning assemblies 7 are located on two opposite sides of the extension platforms 6 along the hinge axes. Each positioning assembly 7 comprises a linkage block 71, a plurality of insertion blocks 72 and an adjustment block 73. The linkage blocks 71 are slidably connected to the oven body 1. The linkage blocks 71 are located on outer sides of the extension platforms 6 and are slid to be close to or away from the extension platforms 6, and sliding directions of the linkage blocks 71 are parallel to the hinge axes of the extension platforms 6. Limiting bumps 8 are integrally fixed on the linkage blocks 71. An outer side wall of the oven body 1 is provided with limiting slots 12. The limiting bumps 8 are slidably connected in the limiting slots 12. The linkage blocks 71 are limited by enabling the limiting bumps 8 to abut against inner walls of the limiting slots 12, such that relative rotation between the linkage blocks 71 and the oven body 1 is prevented.

With reference to FIG. 3 and FIG. 4, the plurality of insertion blocks 72 are fixed on the sides of the linkage blocks 71 that are close to the extension platforms 6, and are evenly and circumferentially distributed at intervals around the hinge axes of the extension platforms 6. Outer side walls of the extension platforms 6 that are close to the insertion blocks 72 are provided with positioning holes 61. The positioning holes 61 are used for the insertion blocks 72 to pass through. The adjustment blocks 73 are located on the sides of the linkage blocks 71 that are away from the insertion blocks 72, and are in threaded connection to the oven body 1, and the adjustment blocks 73 and the linkage blocks 71 are rotatably connected. Rotation axes of the adjustment blocks 73 and the linkage blocks 71 are parallel to the hinge axes of the extension platforms 6.

In actual use, when the extension platforms 6 need to be flipped, the adjustment blocks 73 are twisted, and the adjustment blocks 73 drive the linkage blocks 71 to move away from the extension platforms 6, such that the insertion blocks 72 are disengaged from the positioning holes 61, and the extension platforms 6 can be rotated until the extension platforms 6 are rotated to corresponding positions and the positioning holes 61 are aligned with the insertion blocks 72. The adjustment blocks 73 are then twisted in opposite directions, and the adjustment blocks 73 drive the linkage blocks 71 to move close to the extension platforms 6, such that the insertion blocks 72 pass through the positioning holes 61, and the extension platforms 6 can be positioned by enabling the insertion blocks 72 to abut against inner walls of the positioning holes 61.

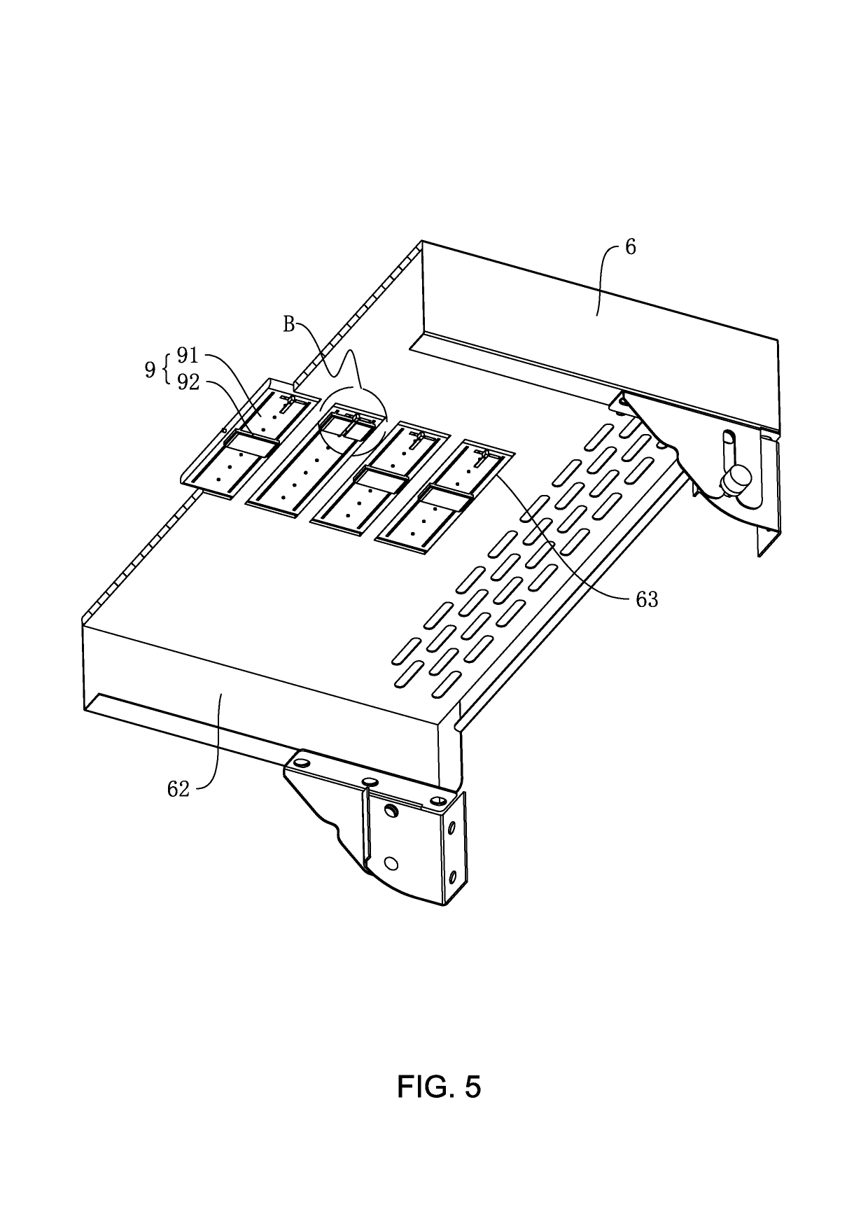

With reference to FIG. 2 and FIG. 5, outer side walls of the extension platforms 6 are provided with accommodating grooves 62. When the extension platforms 6 are horizontal, the accommodating grooves 62 are located below the extension platforms 6. The outer side walls of the extension platforms 6 that are away from the accommodating grooves 62 are provided with a plurality of through holes 63. The plurality of through holes 63 are evenly distributed at intervals towards a direction away from the oven body 1, and distribution directions of the through holes 63 are perpendicular to the hinge axes of the extension platforms 6. The through holes 63 are in communication with the accommodating grooves 62.

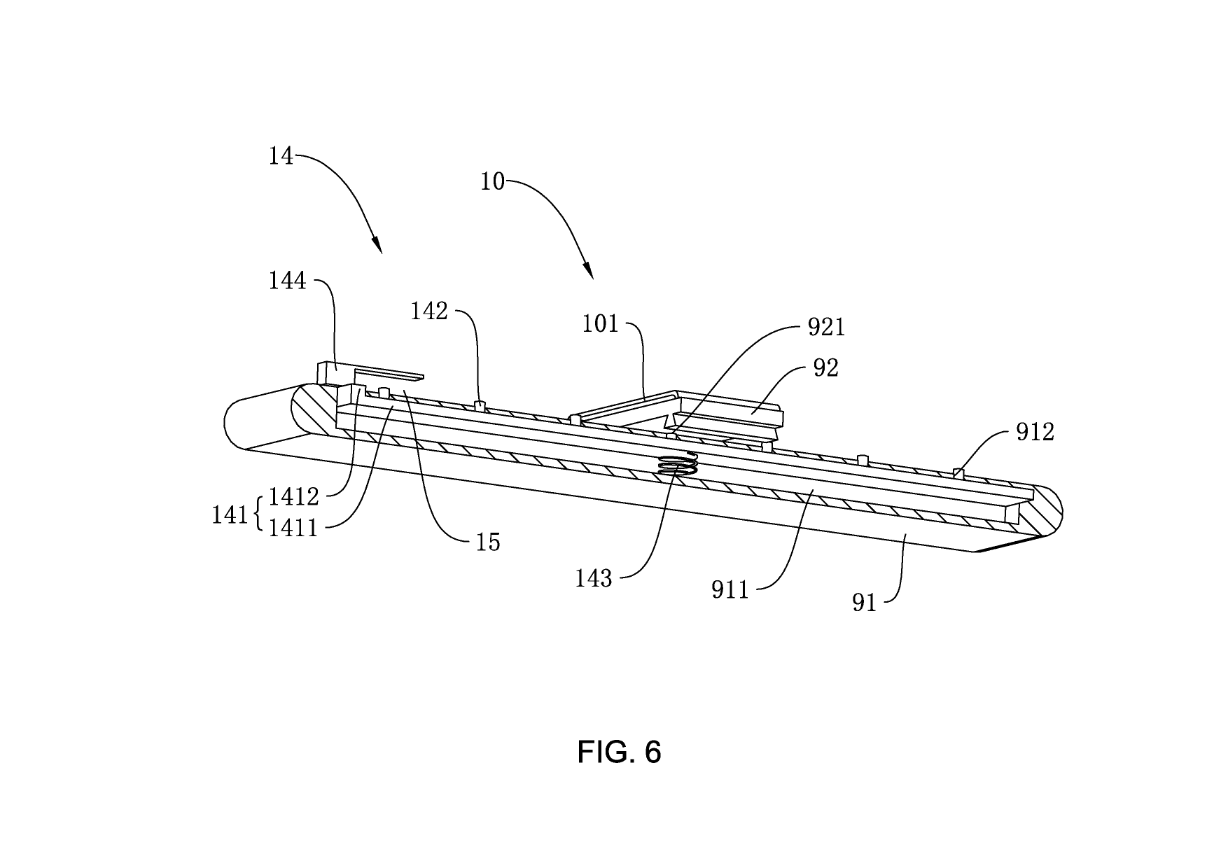

With reference to FIG. 5 and FIG. 6, a flip plate 9 is rotatably connected in each of the through holes 63. Each flip plate 9 comprises a plate body 91 and a sliding block 92. The plate bodies 91 are located in the through holes 63 and rotatably connected to the extension platforms 6, and rotation axes of the plate bodies 91 are perpendicular to the hinge axes of the extension platforms 6. Each sliding block 92 is located on one side of the plate body 91 and slidably connected to the plate bodies 91, and sliding directions of the sliding blocks 92 are perpendicular to the rotation axes of the plate bodies 91. Two sliding rails are fixed on end surfaces of the sliding blocks 92 that are close to the plate bodies 91. The two sliding rails are located on two opposite ends of the sliding blocks 92, respectively. Outer side walls of the plate bodies 91 are provided with sliding slots for accommodating the sliding rails. The sliding rails are slidably connected in the sliding slots along sliding directions of the sliding blocks 92. The sliding blocks 92 are slidably connected to the plate bodies 91 by means of mating between the sliding rails and the sliding slots.

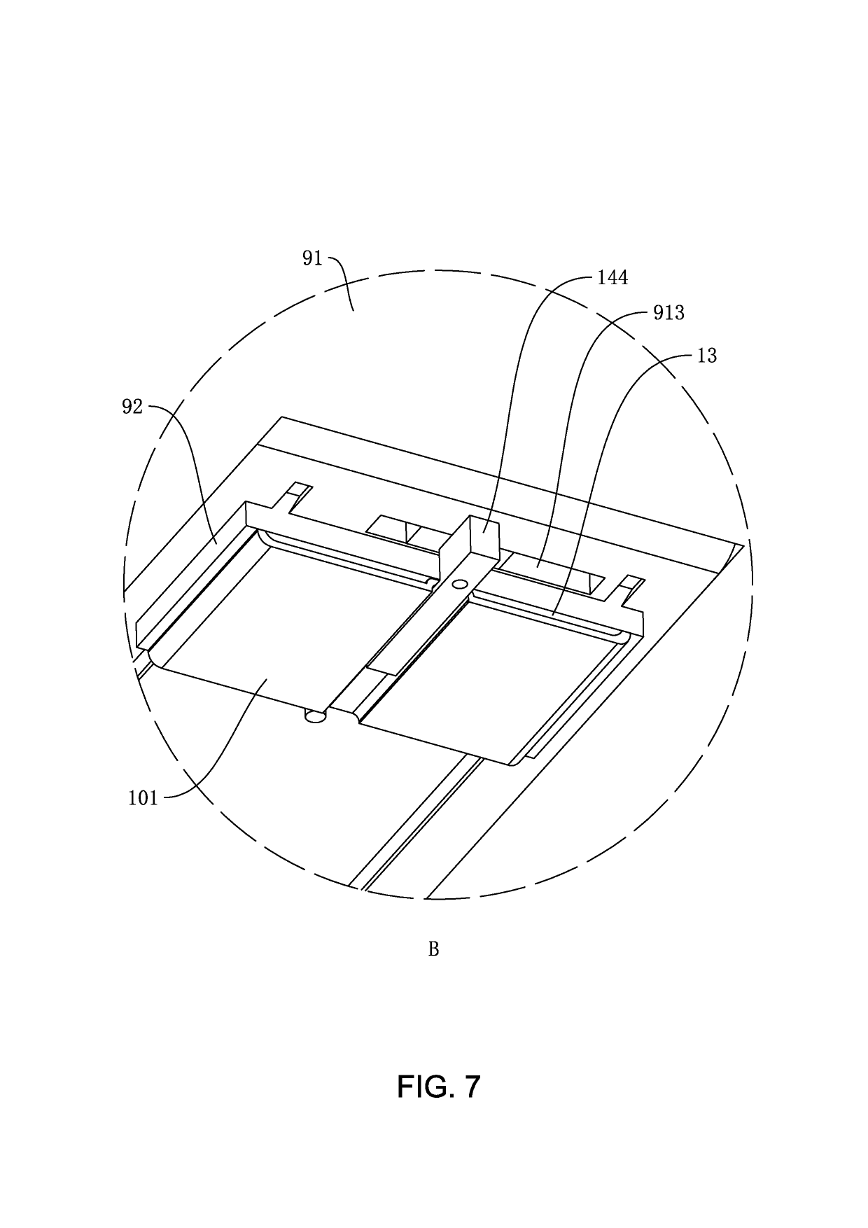

With reference to FIG. 6 and FIG. 7, the sliding blocks 92 are provided with clamping members 10. The clamping members 10 are located on the sides of the sliding blocks 92 that are away from the plate bodies 91. In the present embodiment, the clamping members 10 are elastic pieces 101. The elastic pieces 101 are fixedly connected to the sliding blocks 92 along two opposite ends of the rotation axes of the plate bodies 91. The elastic pieces 101 and the sliding blocks 92 are spliced to form perforation holes 13. The perforation holes 13 are used for items to pass through.

With reference to FIG. 6 and FIG. 7, the plate bodies 91 are provided with locking assemblies 14. The locking assemblies 14 comprise movable blocks 141, a plurality of snap blocks 142, second elastic members 143, and limiting blocks 144. Accommodating cavities 911 are formed in the plate bodies 91. The movable blocks 141 comprise sliding portions 1411 and connecting portions 1412. The sliding portions 1411 are slidably connected in the accommodating cavities 911, and the sliding portions 1411 are slid to be close to or away from the sliding blocks 92. The connecting portions 1412 are fixed on the sides of the sliding portions 1411 that are close to the sliding blocks 92, and penetrate out of the plate bodies 91. The plurality of snap blocks 142 are all fixed on the sides of the sliding portions 1411 that are close to the sliding blocks 92, and are evenly distributed at intervals along sliding directions of the sliding blocks 92. Outer side walls of the plate bodies 91 that are close to the sliding blocks 92 are provided with a plurality of avoiding holes 912. The number and positions of the avoiding holes 912 correspond to the number and positions of the snap blocks 142 on a one-to-one basis, and the avoiding holes 912 are in communication with the accommodating cavities 911. Each snap block 142 is located in the corresponding avoiding hole 912. Outer side walls of the sliding blocks 92 that are close to the snap blocks 142 are provided with snap slots 921. The snap slots 921 are used for the snap blocks 142 to snap thereinto.

With reference to FIG. 6, the second elastic members 143 are located in the accommodating cavities 911 and are located on the sides of the sliding portions 1411 that are away from the sliding blocks 92, and two opposite ends of the second elastic members 143 are fixedly connected to the plate bodies 91 and the sliding portions 1411, respectively. The second elastic members 143 tightly abut against the sliding portions 1411, such that the sliding portions 1411 have a tendency to be close to the sliding blocks 92. In the present embodiment, the second elastic members 143 are springs.

With reference to FIG. 6 and FIG. 7, the limiting blocks 144 are located on the sides of the plate bodies 91 that are close to the sliding blocks 92, and are rotatably connected to the connecting portions 1412, and rotation axes of the limiting blocks 144 are parallel to sliding directions of the sliding portions 1411. Outer side walls of the plate bodies 91 that are close to the sliding blocks 92 are provided with avoiding slots 913. The avoiding slots 913 are used for the limiting blocks 144 to snap thereinto. When the limiting blocks 144 are snapped into the avoiding slots 913, the snap blocks 142 are disengaged from the snap slots 921. The limiting blocks 144 and the plate bodies 91 are spliced to form recesses 15. The recesses 15 are located on the sides of the limiting blocks 144 that are close to the sliding blocks 92. The recesses 15 are used for the sliding blocks 92 and the elastic pieces 101 to snap thereinto.

In actual use, when tools having large differences in size of various parts need to be clamped, the tools may pass through the perforation holes 13, and the elastic pieces 101 are used to tightly abut the tools against the sliding blocks 92 to achieve clamping. Then, the limiting blocks 144 are twisted, such that the limiting blocks 144 are aligned with the avoiding slots 913. Then, the limiting blocks 144 are pressed to drive the sliding portions 1411 to move away from the sliding blocks 92, such that the limiting blocks 144 are snapped into the avoiding slots 913, and the snap blocks 142 are disengaged from the snap slots 921. Thus, the sliding blocks 92 can be moved until the entire clamped tools are located in the accommodating grooves 62, and the snap slots 921 are aligned with the snap blocks 142. The limiting blocks 144 are then released, the sliding portions 1411 drive, under the action of the second elastic members 143, the snap blocks 142 to be snapped into the snap slots 921, and the sliding blocks 92 can thus be positioned by enabling the snap blocks 142 to abut against inner walls of the snap slots 921. Then, the limiting blocks 144 are twisted, such that the limiting blocks 144 are staggered from the avoiding slots 913, and the limiting blocks 144 are limited by enabling the plate bodies 91 to abut against the limiting blocks 144, thereby improving the stability of positioning of the sliding blocks 92.

When a size of the tool is smaller than that of the perforation hole 13, the sliding block 92 can be moved to be close to the limiting block 144, such that the sliding block 92 and the elastic piece 101 are snapped into the recess 15; and the limiting block 144 tightly abuts against the elastic piece 101, thereby dividing the perforation hole 13 into smaller apertures, and making it convenient to clamp the tool of the size smaller than the perforation hole 13. The multifunctional oven in the embodiments of the present application has an implementation principle as follows.

When tools and the oven need to be transported to a barbecue location together, the plate bodies 91 can be flipped, such that the clamping members 10 are located in the accommodating grooves 62; and the tools are then clamped by the clamping members 10, and the extension platforms 6 are then flipped, such that the extension platforms 6 abut against the oven body 1, and the extension platforms 6 are positioned. In this case, the tools can be stored in the accommodating grooves 62, such that a space occupied by the tools is reduced; and the tools are clamped by the clamping members 10 to be positioned, such that the tools can be prevented from being damaged by collision with each other during transportation, and the usability of the oven is improved.

When the oven is used, the extension platforms 6 can be flipped, such that the extension platforms 6 are horizontal, and the extension platforms 6 are positioned. The tools required for barbecue are then removed from the clamping members 10, and the plate bodies 91, on which the clamping members 10 do not clamp items, are then flipped, such that the clamping members 10 are located above the extension platforms 6. In this case, tools that are not required for the moment can be clamped by the clamping members 10 to reduce the situation that the tools fall from the extension platforms 6, so as to be convenient for workers to take and use. Baked and plated foods can further be placed between the clamped tools and the oven body 1 to limit the position of the foods, such that the situation that the plated foods fall from the extension platforms 6 due to accidental collision in a process of taking items is reduced.

The above all are preferred embodiments of the present application, which are not intended to limit the scope of protection of the present application. Therefore, all equivalent changes made according to the structure, shape and principle of the present application should be covered within the scope of protection of the present application.

What is claimed is:

1. A multifunctional oven, comprising an oven body (1) and a grill (2) detachably connected to the oven body (1), characterized in that: extension platforms (6) are hinged on the oven body (1); the extension platforms (6) are flipped to be close to or away from the oven body (1); the oven body (1) is provided with positioning assemblies (7) for positioning the extension platforms (6); the extension platforms (6) are provided with accommodating grooves (62); when the extension platforms (6) are horizontal, the accommodating grooves (62) are located below the extension platforms (6); the extension platforms (6) are provided with a plurality of through holes (63); the plurality of through holes (63) are distributed towards a direction away from the oven body (1); the through holes (63) are in communication with the accommodating grooves (62); flip plates (9) are rotatably connected in the through holes (63); rotation axes of the flip plates (9) are perpendicular to hinge axes of the extension platforms (6); and the flip plates (9) are provided with clamping members (10).

2. The multifunctional oven according to claim 1, characterized in that: the clamping members (10) are elastic pieces (101), two opposite ends of the elastic pieces (101) are connected to the flip plates (9), and the elastic pieces (101) and the flip plates (9) are spliced to form perforation holes (13).

3. The multifunctional oven according to claim 1, characterized in that: the flip plates (9) comprise plate bodies (91) rotatably connected to the extension platforms (6) and sliding blocks (92) slidably connected to the plate bodies (91); the clamping members (10) are provided on the sliding blocks (92); sliding directions of the sliding blocks (92) are perpendicular to rotation axes of the plate bodies (91); and the plate bodies (91) are provided with locking assemblies (14) for positioning the sliding blocks (92).

4. The multifunctional oven according to claim 3, characterized in that: each locking assembly (14) comprises a movable block (141) slidably connected to the plate body (91), a plurality of snap blocks (142) provided on the movable block (141), a second elastic member (143) provided on the plate body (91), and a limiting block (144) rotatably connected to the movable block (141); the movable block (141) is moved to be close to or away from the sliding block (92); the plurality of snap blocks (142) are distributed along the sliding direction of the sliding block (92); the sliding block (92) is provided with snap slots (921) for the snap blocks (142) to snap thereinto; the second elastic member (143) tightly abuts against the movable block (141), such that the movable block (141) has a tendency to be close to the sliding block (92); the plate body (91) is provided with an avoiding slot (913) for the limiting block (144) to snap thereinto; and when the limiting block (144) is snapped into the avoiding slot (913), the snap blocks (142) are disengaged from the snap slots (921).

5. The multifunctional oven according to claim 4, characterized in that: the limiting block (144) and the plate body (91) are spliced to form a recess (15), and the recess (15) is located on the side of the limiting block (144) that is close to the sliding block (92), and the recess (15) is for the sliding block (92) and the elastic piece (101) to snap thereinto.

6. The multifunctional oven according to claim 1, characterized in that the positioning assemblies (7) comprise linkage blocks (71) slidably connected to the oven body (1), a plurality of insertion blocks (72) provided on the linkage blocks (71), and adjustment blocks (73) in threaded connection to the oven body (1); the linkage blocks (71) are slid to be close to or away from the extension platforms (6); the plurality of insertion blocks (72) are located on the sides of the linkage blocks (71) that are close to the extension platforms (6), and are circumferentially distributed around the hinge axes of the extension platforms (6); the extension platforms (6) are provided with positioning holes (61) for the insertion blocks (72) to pass through; and the adjustment blocks (73) and the linkage blocks (71) are rotatably connected.

7. The multifunctional oven according to claim 1, characterized in that: the grill (2) is provided with a plurality of mounting columns (3), and the oven body (1) is provided with mounting slots (11) for the mounting columns (3) to snap thereinto.

8. The multifunctional oven according to claim 7, characterized in that: the grill (2) comprises a base plate (21) provided on the oven body (1) and a cover body (22) provided on the base plate (21); the mounting columns (3) are provided on the base plate (21); the cover body (22) and the base plate (21) are spliced to form a heating space (4); the cover body (22) is provided with a thermometer (5); and a temperature sensing element of the thermometer (5) extends into the heating space (4).
